(19) United States
(12) Patent Application Publication
(10) Pub. No.: US 2015/0020327 A1
(43) Pub. Date: Jan. 22, 2015

(54) BAND-SAW CLEANING MECHANISM FOR BAND SAW MACHINE

(71) Applicant: National Chung Cheng University, Chia-Yi County (TW)

(72) Inventors: Yeau-Ren JENG, Tainan City (TW); Yu-Xian HUANG, Tainan City (TW)

(21) Appl. No.: 13/944,274

(22) Filed: Jul. 17, 2013

(51) Int. Cl. B23D 63/00; B27B 13/16; B23Q 11/02; B23D 59/00

(52) U.S. Cl. CPC B23D 63/001; B23D 59/006; B27B 13/16; B23Q 11/02
USPC 15/88.3

(57) ABSTRACT

A band-saw cleaning mechanism includes a cleaning unit having a steel brush, a first motor having a driving shaft, and a linking rod connected between the steel brush the driving shaft; a torque sensor mounted to the driving shaft for sensing the torque of the driving shaft and for emitting a sensing signal; a regulation unit having a second motor and a regulation screw having two ends connected with the second motor and the linking rod, respectively; and the control unit connected with the torque sensor and the second motor for controllably making the second motor regulate the regulation screw for prolongation according to the sensing signal. While the regulation screw is prolonged, the linking rod can be pushed to change the contact distance between the steel brush and the band saw for proper contact therebetween.

### BACKGROUND OF THE INVENTION

1. Field of the Invention

The present invention relates generally to a band saw machine and more particularly, to a band-saw cleaning mechanism for a band saw machine.

2. Description of the Related Art

Generally speaking, a steel brush usually works with the band saw of a conventional band saw machine in the process of cutting a workpiece for cleaning sawdust remaining on the surface of the band saw to prevent the sawdust from damage to the workpiece or the band saw. After used a long time, the steel brush will have increasing wear and tear to disable the steel brush from keeping proper contact with the band saw to further adversely affect the cutting efficiency and service life of the band saw. For this reason, it is necessary to periodically manually check whether the steel brush and the band saw keep proper contact with each other.

To solve the aforesaid problem, Taiwan Pat. Pub. No. 265658 disclosed that a support member fastens a steel brush to a location which is properly close to the band saw to prevent the steel brush from excessive wear and tear. Besides, there is another conventional band saw, in which none of any steel brush is available. For example, Taiwan Pat. Pub. No. M244143 disclosed that a high-pressure air is employed to blow away the sawdust from the band saw; Taiwan Pat. No. 1238764 disclosed that the suction generated by a running fan impeller can suck the sawdust and then the sawdust can be ejected out of the band saw machine. However, each of the aforesaid conventional structures is very complicated to lead to more production cost.

### SUMMARY OF THE INVENTION

The primary objective of the present invention is to provide a band-saw cleaning mechanism, which is structurally simple and can keep the band saw preferably clean in the process of cutting to further enhance the cutting efficiency and service life of the band saw.

The foregoing objective of the present invention is attained by the band-saw cleaning mechanism formed of a cleaning unit, a torque sensor, a regulation unit, and a control unit. The cleaning unit includes a steel brush, a first motor, and a linking rod. The first motor includes a driving shaft. The linking rod includes two ends, one of which is connected with the steel brush and the other is pivotably attached to the driving shaft of the first motor and in this way, the linking rod can be driven by the first motor to make the steel brush clean a surface of the band saw. The torque sensor is mounted to the driving shaft of the first motor for sensing the torque of the driving shaft and for emitting a sensing signal. The regulation unit includes a second motor and a regulation screw. The regulation rod includes two ends, one of which is connected with the second motor and the other is pivotably attached to the linking rod of the cleaning unit. The control unit is electrically connected with the torque sensor and the second motor of the regulation unit for receiving the sensing signal of the torque sensor and controllably making the second motor regulate the regulation screw for prolongation according to the sensing signal and while the regulation screw is prolonged, the regulation screw can push the linking rod to change the contact distance between the steel brush and the band saw for proper contact therebetween.

### BRIEF DESCRIPTION OF THE DRAWINGS

FIG. 1 is a plan view of a preferred embodiment of the present invention.

FIG. 2 is a structural schematic view of the preferred embodiment of the present invention.

FIG. 3 is similar to FIG. 2, illustrating that the regulation screw is prolonged.

### DETAILED DESCRIPTION OF PREFERRED EMBODIMENTS

Structural features and desired effects of the present invention will become more fully understood by reference to a preferred embodiment given hereunder. However, it is to be understood that the embodiment is given by way of illustration only, thus is not limitative of the claim scope of the present invention.

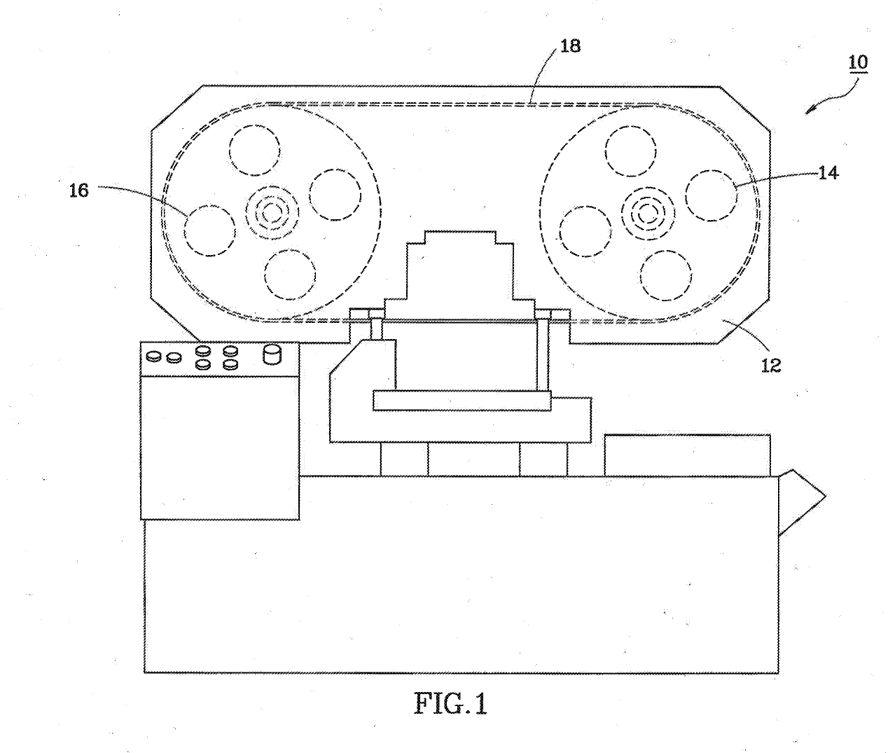

Referring to FIG. 1, a band saw machine 10 of the present invention is formed of a working bench 12, a driving wheel 14 mounted to the working bench 12, a driven wheel 16 mounted to the working bench 12 relative to the driving wheel 14, and a band saw 18 running on the driving and driven wheels 14 and 16. When the driving wheel 14 is driven by a motor (not shown) mounted to the working bench 12 to start with rotation, the band saw 18 can be towed to make the driven wheel 16 rotate to further make the band saw 18 keep running on the driving and driven wheels 14 and 16 for cutting a workpiece (not shown).

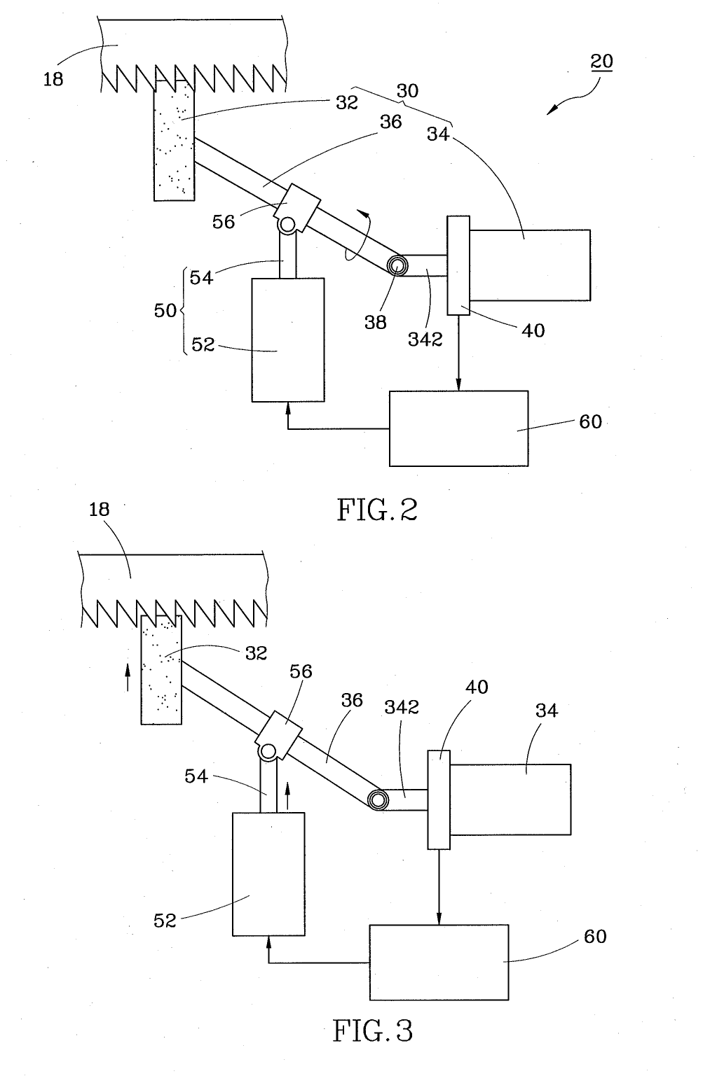

Referring to FIG. 2, a band-saw cleaning mechanism 20 constructed according to a preferred embodiment of the present invention. The band-saw cleaning mechanism 20 is formed of a cleaning unit 30, a torque sensor 40, a regulation unit 50, and a control unit 60. The detailed descriptions and operations of these elements as well as their interrelations are recited in the respective paragraphs as follows.

The cleaning unit 30 includes a steel brush 32, a first motor 34, and a linking rod 36. The first motor 34 is a hydraulic motor as an example in this embodiment and includes a driving shaft 342. The linking rod 35 includes two ends, one of which is connected with the steel brush 32 and the other is pivotably attached to the driving shaft 342 via a ball-and-socket joint 38. When the driving shaft 342 starts with rotation, the linking rod 36 drives the steel brush 32 to pivot relative to the band saw 18 on the ball-and-socket joint 38 to make the steel brush 32 clean a surface of the band saw 18.

The torque sensor 40 is installed to the driving shaft 342 for sensing how much the torque is while the driving shaft 342 rotates and for emitting a sensing signal at any time.

The regulation unit 50 includes a second motor 52 and a regulation screw 54. The second motor 52 is a low-speed motor as an example in this embodiment. The regulation screw 54 includes two ends, one of which is connected with the second motor 52 and the other is pivotably attached to a bushing 56, which is slidably sleeved onto the linking rod 36. In this way, the regulation screw 54 can be driven by the second motor 52 for prolongation or shortening and while the regulation screw 54 is prolonged or shortened, the linking 36 can be pushed or pulled via the bushing 56 synchronously to change the contact distance between the steel brush 32 and the band saw 18 for proper contact therebetween.

The control unit 60 is electrically connected with the torque sensor 40 and the second motor 52 for controlling operation of the second motor 52 according to the torque sensor 40.

In light of the structures mentioned above, in the process of cutting the workpiece with the band saw 18, the driving wheel 342 can drive the steel brush 32 through the linking rod 36 to clean the surface of the band saw 18 synchronously. In the meantime, the torque sensor 40 can measure the torque of the driving shaft 342 is at any time; once the torque sensor 40 senses that the torque of the driving shaft 342 becomes small, it indicates that the steel brush 32 has had wear and tear and the steel brush 32 and the band saw 18 do not keep proper contact distance, and next, the control unit 60 can controllably make the second motor 52 drive the regulation screw 54 for prolongation to make the regulation screw 54 push the linking rod 36 through the bushing 56 to make the steel brush 32 approach the band saw 18. As shown in FIGS. 2 and 3, when the torque sensor 40 senses that the torque of the driving shaft 342 returns to a default, it indicates that the steel brush 32 and the band saw 18 keep proper contact with each other therebetween and meanwhile, the control unit 60 can controllably stop the second motor 52.

In conclusion, the band saw machine 10 of the present invention can monitor the torque of the driving shaft 342 in real time through the torque sensor 40 to make the control unit 60 change the power output of the second motor 52 to the regulation screw to further change the contact distance between the steel brush 32 and the band saw 18. In this way, the present invention can not only have simple structure and decrease the production cost but secure proper cleanliness of the band saw 18 for enhanced cutting efficiency and service life of the band saw 18.

What is claimed is:

1. A band-saw cleaning mechanism for a band saw machine, comprising:
a cleaning unit having a steel brush, a first motor, and a linking rod, the steel brush being adapted for contact with a surface of the band saw, the first motor having a driving shaft, the linking rod having two ends, one of which is connected with the steel brush and the other is pivotably attached to the driving shaft of the first motor;
a torque sensor mounted to the driving shaft of the first motor for sensing a torque of the driving shaft and emitting a sensing signal;
a regulation unit having a second motor and a regulation screw, the regulation screw having two ends, one of which is connected with the second motor and the other is pivotably attached to the linking rod of the cleaning unit, whereby the regulation screw is driven by the second motor to push the linking rod for changing a contact distance between the steel brush and the band saw; and
a control unit electrically connected with the torque sensor and the second motor of the regulation unit for receiving the sensing signal from the torque sensor and controlling the operation of the second motor according to the sensing signal.

2. The band-saw cleaning mechanism as defined in claim 1, wherein the linking rod is pivotably attached to the driving shaft of the first motor via a ball-and-socket joint.

3. The band-saw cleaning mechanism as defined in claim 1, wherein the regulation screw comprises two ends, one of which is pivotably attached to a bushing, the bushing being slidably sleeved onto the linking rod.
